(19) United States
(12) Patent Application Publication
(10) Pub. No.: US 2017/0090346 A1
(43) Pub. Date: Mar. 30, 2017

(54) DEVELOPER-CONTAINING VESSEL AND IMAGE FORMING APPARATUS

(71) Applicant: FUJI XEROX CO., LTD., Tokyo (JP)

(72) Inventors: Norihiro TAMAZAWA, Kanagawa (JP); Shota OBA, Kanagawa (JP); Ayumi NOGUCHI, Kanagawa (JP); Makoto KANNO, Kanagawa (JP); Keisuke KUBO, Kanagawa (JP); Seigo SHINOZAKI, Kanagawa (JP)

(73) Assignee: FUJI XEROX CO., LTD., Tokyo (JP)

(21) Appl. No.: 15/001,637

(22) Filed: Jan. 20, 2016

(30) Foreign Application Priority Data
Sep. 25, 2015 (JP) 2015-188799

(51) Int. Cl. G03G 15/08

(52) U.S. Cl. CPC G03G 15/0865

(57) ABSTRACT

Provided is a developer-containing vessel including a fixing section that includes a discharge portion through which developer is discharged, a rotation section that includes a container in which the developer is contained and a dispersion member which is supported to be integrally rotatable along with the container and disperses the developer during rotation, and that is supported to be rotatable with respect to the fixing section, and a transport portion that is formed in the container, is inclined with respect to a rotational axis direction of the rotation section, and transports the developer during the rotation of the rotation section.

### CROSS-REFERENCE TO RELATED APPLICATIONS

This application is based on and claims priority under 35 USC 119 from Japanese Patent Application No. 2015-188799 filed Sep. 25, 2015.

### BACKGROUND

### Technical Field

The present invention relates to a developer-containing vessel and an image forming apparatus.

### SUMMARY

According to an aspect of the invention, there is provided a developer-containing vessel including:

a fixing section that includes a discharge portion through which developer is discharged;

a rotation section that includes a container in which the developer is contained and a dispersion member which is supported to be integrally rotatable along with the container and disperses the developer during rotation, and that is supported to be rotatable with respect to the fixing section; and

a transport portion that is formed in the container, is inclined with respect to a rotational axis direction of the rotation section, and transports the developer during the rotation of the rotation section,

wherein the dispersion member includes a first dispersion portion that extends from a rotational center in a radial direction and a second dispersion portion that extends from outer ends of the first dispersion portion in the radial direction, extends in an axial direction, and extends to a position corresponding to the discharge portion.

### BRIEF DESCRIPTION OF THE DRAWINGS

Exemplary embodiments of the present invention will be described in detail based on the following figures, wherein:

FIG. 1 is a view illustrating an overall image forming apparatus of Example 1;

FIG. 2 is an enlarged view of main components of a toner image forming device section in FIG. 1;

FIG. 3 is a perspective view of a toner cartridge of Example 1;

FIG. 4 is a sectional view taken along line IV-IV in FIG. 3;

FIG. 5 is a view illustrating a fin member of Example 1;

FIG. 6 is a view illustrating an experimental example, a shape of a second dispersion unit used in the experimental example, and a modification example of the second dispersion unit; and

FIGS. 7A and 7B are graphs of experimental results, FIG. 7A is a graph having the number of rotations on the horizontal axis and torque on the vertical axis, and FIG. 7B is a graph having motor driving time on the horizontal axis and discharge rate on the vertical axis.

### DETAILED DESCRIPTION

Next, a specific example (hereinafter, referred to as Example) of an exemplary embodiment of the invention is described with reference to the drawings; however the invention is not limited to the following Examples.

Further, for easy understanding of the following description, in the drawings, a frontward-rearward direction is referred to as an X axial direction, a rightward-leftward direction is referred to as a Y axial direction, a upward-downward direction is referred to as a Z axial direction, directions or sides represented by arrows X, −X, Y, −Y, Z, and −Z are referred to as frontward, rearward, rightward, leftward, upward, downward, or the front side, the rear side, the right side, the left side, the upper side, and the lower side.

In addition, in the drawings, “◯” with “•” at the center means an arrow directed from the back of the paper surface to the front thereof and “◯” with “x” at the center means an arrow directed from the front of the paper surface to the back thereof.

Further, in the following description with reference to the drawing, component members other than the component members required for description are appropriately omitted in the drawings for easy understanding.

### Example 1

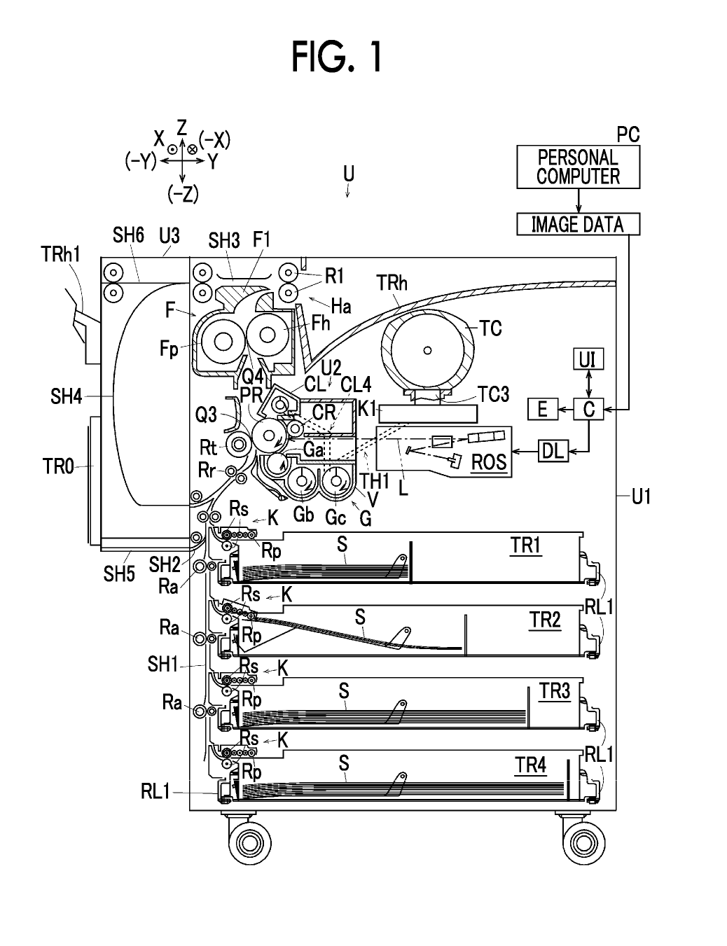

FIG. 1 is a view illustrating an overall image forming apparatus of Example 1.

In FIG. 1, a printer U, as an example of the image forming apparatus of Example 1, includes a printer main body U1, as an example of an apparatus main body. A first discharge tray TRh, as an example of a discharge portion of a first medium, is provided on the top surface of the printer main body U1. An operation unit UI is provided on the top surface in the right section of the printer main body U1. The operation unit UI has a display section or the like (not illustrated). The operation unit UI has a configuration in which a user may perform an input operation.

In the printer U of the Example 1, a host computer, as an example of an image information transmitting apparatus, is illustrated, and specifically, a personal computer is electrically connected to the printer.

The printer U includes a controller C, as an example of a control unit. The controller C may receive an electrical signal such as image information transmitted from the personal computer PC or a control signal. In addition, the controller C is configured to be able to output a control signal to the operation unit UI or an electric circuit E. Further, the controller C is electrically connected to a writing circuit DL.

The writing circuit DL outputs a drive signal in response to input information to an exposure machine ROS, as an example of a writing device. The exposure machine ROS is configured to be able to output a laser beam. L, as an example of a writing beam, in response to an input signal.

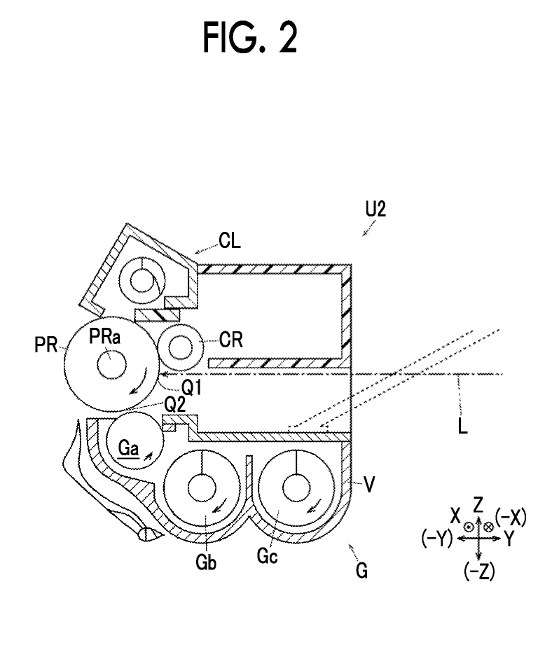

FIG. 2 is an enlarged view of main components of a toner image forming device section in FIG. 1.

In FIG. 1 and FIG. 2, a photoreceptor PR, as an example of an image holding member, is disposed on the left side of the exposure machine ROS. The photoreceptor PR of Example 1 is supported so as to be rotatable around a rotation axis PRa in an arrow direction. In the photoreceptor PR, a writing region Q1 is irradiated with the laser beam L.

A charging roll CR as an example of a charging member, a developing device G, and a photoreceptor cleaner CL as an example of a cleaner for an image holding member are disposed in the vicinity of the photoreceptor PR along a rotating direction of the photoreceptor PR.

Further, in the printer U of Example 1, the photoreceptor PR or the charging roll CR, the developing device G, and the photoreceptor cleaner CL are integrated as an attachable and detachable unit. In other words, the photoreceptor PR or the charging roll CR, the developing device G, and the photoreceptor cleaner CL, as a processing unit U2, are configured to be attachable to and detachable from the printer main body U1.

Charged voltage is applied to the charging roll CR from the electric circuit E.

The developing device G has a developing vessel V in which toner, as an example of developer is contained. A developing roll Ga, as an example of a holding member of developer, is rotatably supported inside the developing vessel V. The developing roll Ga is disposed to face the photoreceptor PR in a developing region Q2.

In addition, developing voltage is applied to the developing roll Ga from the electric circuit E. In addition, augers Gb and Gc, as an example of a developer transport member, are rotatably supported inside the developing vessel V.

A toner image forming device that forms a toner image on the photoreceptor PR is configured to have the photoreceptor PR, the charging roll CR, the exposure machine ROS, and the developing device G.

One end of a supply path of a toner supply device TH1, as an example of a developer supply device, which is fixed to and supported in the printer U, is connected to the developing vessel V. The other end of the supply path of the toner supply device TH1 is connected to a toner cartridge TC, as an example of a developer-containing vessel.

The toner cartridge TC is configured to be attachable to and detachable from the printer U by inserting into and removing from the printer in the frontward-rearward direction.

In FIG. 1, multiple paper feeding trays TR1 to TR4, as an example of a medium accommodating unit, are provided in the lower section of the printer U. The multiple paper feeding trays TR1 to TR4 accommodates a recording sheet S, as an example of a medium.

In FIG. 1, rails RL1, as an example of a containing-unit guiding member, are disposed on both right and left sides of the respective paper feeding trays TR1 to TR4. The rails RL1 are supported so as to be able to cause both right and left end portions of the paper feeding trays TR1 to TR4 to move. Accordingly, the paper feeding trays TR1 to TR4 are supported so as to be able to exit from and enter the printer in the frontward-rearward direction by the pair of right and left rails RL1.

In FIG. 1, a paper feeding device K is disposed in the upper left portion from the respective paper feeding trays TR1 to TR4. The paper feeding device K includes a pick-up roll Rp, as an example of a medium fetching member. A sorting roll Rs, as an example of a sorting member, is disposed on the left side of the pick-up roll Rp. The sorting roll Rs is configured to have a feeding roll, as an example of a medium transport member, and a retard roll, as an example of a medium separating member.

A paper feeding path SH1, as an example of a medium transport path, is disposed on the left side of the paper feeding device K. The paper feeding path SH1 extends upward. Multiple transport rolls Ra, as an example of a medium transport member, are disposed in the paper feeding path SH1. A registration roll Rr, as an example of a medium transport time adjusting member, is disposed at the upper end as the downstream end of the paper feeding path SH1.

In addition, a manual feed tray TR0, as an example of a manual feed unit, is mounted on the left side portion of the printer U. The left end of a manual feed path SH2, as an example of a manual feeding transport path, is connected to the right portion of the manual feed tray TR0. The right end of the manual feed path SH2 is connected to the paper feeding path SH1.

In FIG. 1, a transfer roll Rt, as an example of a transfer device, is disposed above the registration roll Rr. The transfer roll Rt faces and comes into contact with the photoreceptor PR in a transfer region Q3. Accordingly, the transfer roll Rt of Example 1 is driven to rotate along with the rotation of the photoreceptor PR. Transfer voltage is applied to the transfer roll Rt from the electric circuit E.

The photoreceptor cleaner CL is disposed on the downstream side of the transfer roll Rt in the rotational direction of the photoreceptor PR. A collection path CL4, as an example of a developer transport path, is supported in the photoreceptor cleaner CL. The collection path CL4 extends from the photoreceptor cleaner CL to the developing device G.

In FIG. 1, a fixing device F is supported above the transfer roll Rt. The fixing device F includes a heating roll Fh, as an example of a heat-fixing member, and a pressure roll Fp, as an example of a pressure-fixing member. The heating roll Fh and the pressure roll Fp come into contact with each other in a fixing region Q4. Transmission of driving from a driving source (not illustrated) to the heating roll Fh is performed and the heating roll rotates. In addition, power with which a heater performs heating (not illustrated) is supplied to the heating roll Fh from the electric circuit E.

An image recording unit U2+Rt+F, which records an image on the sheet S, is configured to include the processing unit U2, as an example of the toner image forming device, the transfer roll Rt, and the fixing device F.

A sheet guide F1, as an example of a medium guiding unit, is formed on the upper portion of the fixing device F. A paper discharge roll R1, as an example of a medium discharging member, is disposed on the right side of the sheet guide F1. A medium discharge port Ha is formed on the right side of the paper discharge roll R1. A first discharge tray TRh is disposed below the medium discharge port Ha.

In FIG. 1, a connection path SH3, as an example of the medium transport path, is disposed above the fixing device F and the left side of the paper discharge roll R1. The connection path SH3 extends leftward from a discharge port Ha of the medium.

A reverse unit U3, as an example of a medium reversing device, is supported above the manual feed tray TR0 on the left side surface of the printer main body U1. A reverse path SH4, as an example of a medium transport path, is formed inside the reverse unit U3. The left end of the connection path SH3 is connected to the upper end of the reverse path SH4. The lower end of the reverse path SH4 joins to the paper feeding path SH1 on the upstream side of the registration roll Rr.

In addition, a second discharge path SH6, as an example of a medium transport path, is formed above the reverse unit U3. The second discharge path SH6 has the right end, which is connected to the connection path SH3, and is diverged from the reverse path SH4. The left end of the second discharge path SH6 extends to the left side surface of the reverse unit U3. A face-up tray RTh1, as an example of a second discharge portion, is supported on the left side section of the reverse unit U3. Accordingly, in the configuration, the sheet S which has passed the second discharge path SH6 may be discharged from the face-up tray TRh1.

### Function of Image Forming Apparatus

In the printer U of Example 1, which includes the configuration, image information transmitted from the personal computer PC is input to the controller C. The controller C converts the input image information into latent image forming information at the time, which is set in advance and outputs the information to the writing circuit DL. The exposure machine ROS outputs the laser beam L based on a signal which the writing circuit DL receives. Further, the controller C controls an operation of the operation unit UI, the writing circuit DL, the electric circuit E, or the like.

In FIG. 1 and FIG. 2, the surface of the photoreceptor PR is charged by the charging roll CR to which charged voltage is applied. On the surface of the photoreceptor PR charged by the charging roll CR, an electrostatic latent image is formed by exposing and scanning with the laser beam. L of the exposure machine ROS, in the writing region Q1. The photoreceptor PR surface, on which the electrostatic latent image is formed, passes the developing region Q2 and transfer region Q3 in this order.

In the developing region Q2, the developing roll Ga faces the photoreceptor PR. The developing roll Ga holds the developer inside the developing vessel V, on the surface. Accordingly, by the toner image held on the surface of the developing roll Ga, the electrostatic latent image on the surface of the photoreceptor PR is developed into a toner image, as an example of a visible image. The developer inside the developing vessel V is stirred by the augers Gb and Gc and is circulated.

According to the developing by the developing roll Ga, when the developer inside the developing vessel V is consumed, the developer is supplied from the toner cartridge TC. In other words, depending on the consumed amount of the developer, the toner in the toner cartridge TC is transported to a discharge port TC3. The toner discharged from the discharge port TC3 is transported to the developing vessel V by a supply transport member (not illustrated) in the supply path of the toner supply device TH1.

The sheet S, on which an image is recorded, is accommodated in the respective paper feeding trays TR1 to TR4. The sheet S accommodated in the paper feeding trays TR1 to TR4 is taken out by the pick-up roll Rp of the paper feeding device K. The sheets S taken out by the pick-up roll Rp is separated one by one by the sorting roll Rs. The sheet S separated by the sorting roll Rs is fed to the paper feeding path SH1. The sheet S on the paper feeding path SH1 is transported toward the registration roll Rr by the transport roll Ra.

Further, the sheet S fed from the manual feed tray TR0 is transported to the registration roll Rr through the manual feed path SH2. The sheet S transported to the registration roll Rr is transported to the transfer region Q3 by the registration roll Rr at a right time when the toner image on the surface of the photoreceptor PR moves to the transfer region Q3.

In the transfer region Q3, the toner image on the surface of the photoreceptor PR is transferred to the sheet S passing the transfer region Q3 by the transfer roll Rt, to which transfer voltage is applied.

In FIG. 2, the photoreceptor PR after passing the transfer region Q3 is cleaned by removing toner attached on the surface of the photoreceptor by the photoreceptor cleaner CL. The toner removed by the photoreceptor cleaner CL returns to the inside of the developing vessel V through the collection path CL4. In other words, the developer collected by the photoreceptor cleaner CL is reused in the developing device G.

The photoreceptor PR having the surface cleaned by the photoreceptor cleaner CL is again charged by the charging roll CR.

The sheet S, to which the toner image is transferred in the transfer region Q3, is transported to the fixing region Q4 of the fixing device F in a state in which the toner image has yet to be fixed.

In the fixing region Q4, the sheet S is pinched between the heating roll Fh and the pressure roll Fp and the toner image is heated and fixed.

The sheet S to which the toner image is fixed by the fixing device F is guided by the sheet guide F1 and is transported to the paper discharge roll R1. In a case where the sheet S is discharged to the first discharge tray TRh, the sheet S sent to the paper discharge roll R1 is discharged to the first discharge tray TRh from the medium discharge port Ha.

During duplex printing, the sheet S, on a first surface of which an image is recorded, enters into a state in which the following edge in the transport direction passes though the sheet guide F1, and the paper discharge roll R1 reversely rotates. Accordingly, the sheet S is transported to the reverse path SH4 through the connection path SH3. The sheet S transported to the reverse path SH4 is transported to the registration roll Rr in a state in which the front and back is reversed. Accordingly, the sheet S is again sent to the transfer region Q3 from the registration roll Rr and an image is recorded on a second surface.

In a case where the sheet S is discharged to the face-up tray TRh1, the sheet S, which is transported through the connection path SH3 by reverse rotation of the paper discharge roll R1 is loaded on the second discharge path SH6. Also, the sheet S transported through the second discharge path SH6 is discharged to the face-up tray TRh1.

### Description of Toner Cartridge

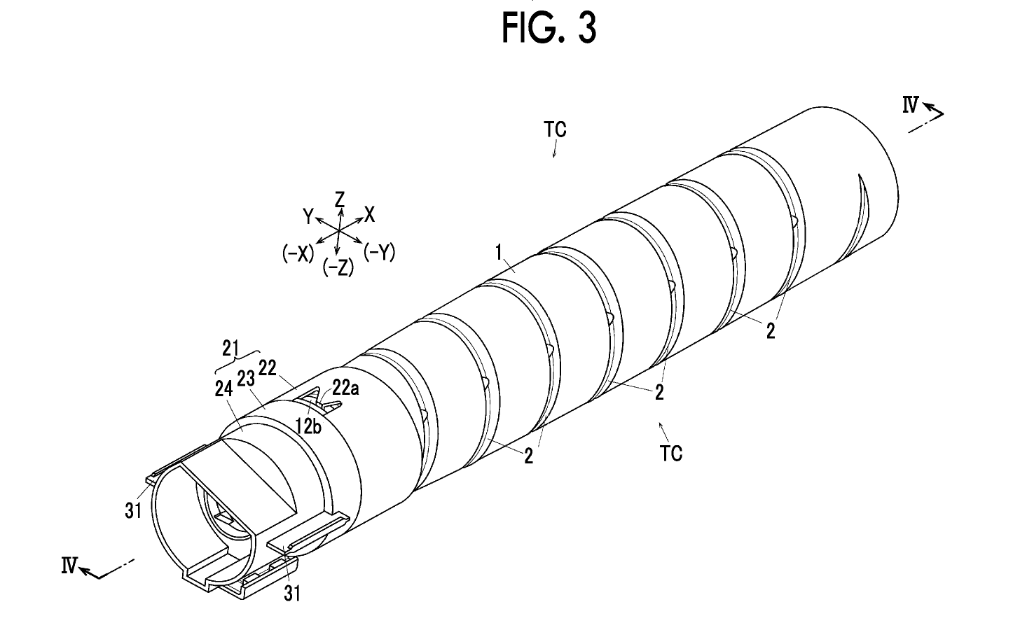

FIG. 3 is a perspective view of the toner cartridge of Example 1.

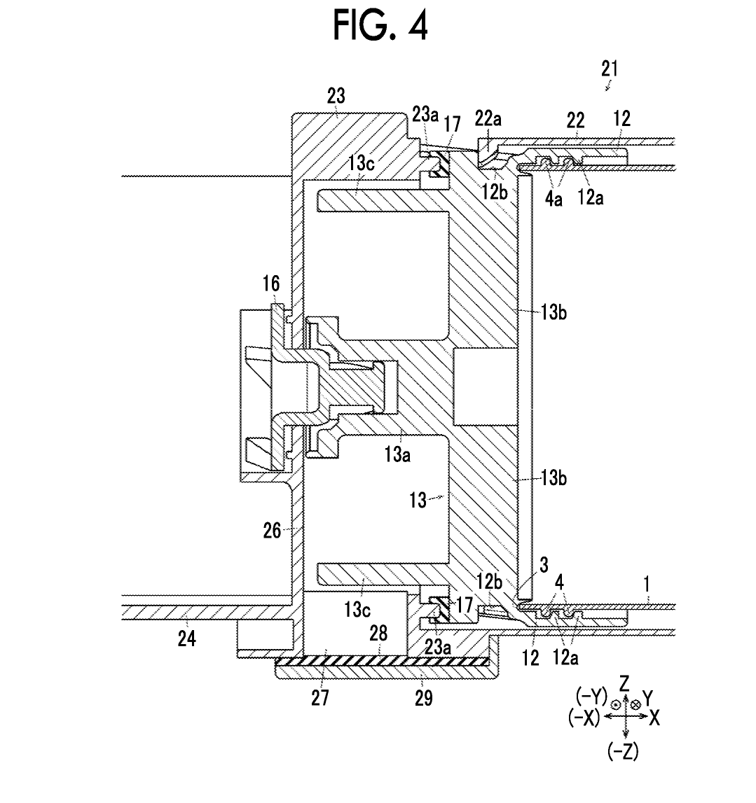

FIG. 4 is a sectional view taken along line IV-IV in FIG. 3.

In FIG. 3 and FIG. 4, the toner cartridge TC of Example 1 includes a bottle 1, as an example of a container. The bottle 1 is formed to have a cylindrical shape extending in the frontward-rearward direction and is configured such that the developer may be contained in the inside of the bottle. A spiral groove 2, as an example of a transport portion, is formed in a wall surface of the bottle 1. In FIG. 3 and FIG. 4, an opening 3 is formed in the rear end of the bottle 1. A threaded portion 4, as an example of fastening portion, is formed at a position of the opening 3 on the front side on the outer surface of the bottle 1.

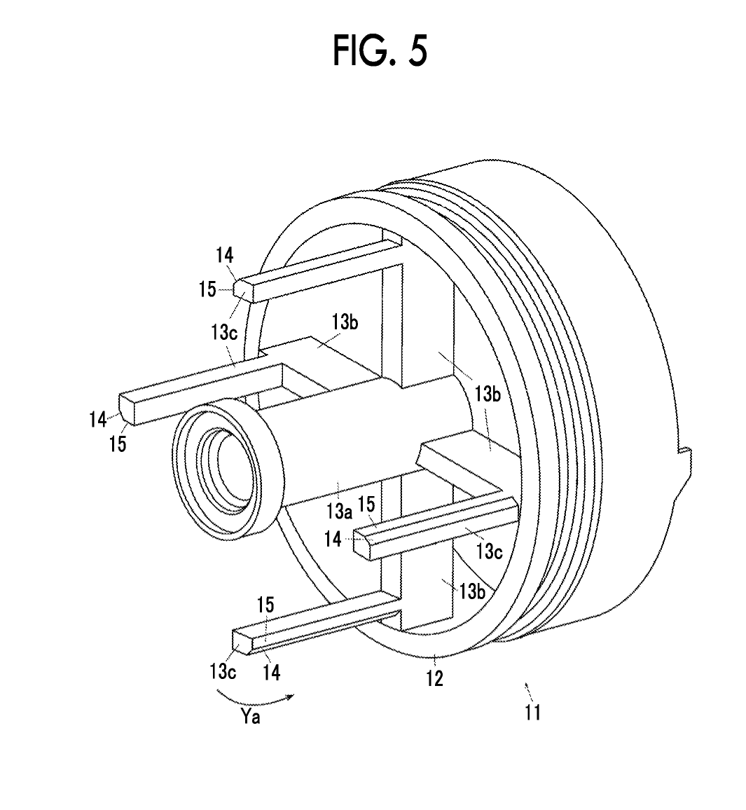

FIG. 5 is a view illustrating a fin member of Example 1.

In FIG. 3 to FIG. 5, a fin member 11, as an example of a dispersion member, is disposed on the rear side of the bottle 1. The fin member 11 has a cylindrical section 12 on the front side, and a fin main body 13 on the rear side. In the cylindrical section 12, a threaded portion 12a, as an example of the fastening portion, is formed on the inner circumferential surface thereof. The threaded portion 12a is formed to correspond to the threaded portion 4. Hence, the threaded portion 12a and the threaded portion 4 are meshed and the fin member 11 and the bottle 1 are fastened. Accordingly, rotation sections 1 and 11 of Example 1 are configured to include the fin member 11 and the bottle 1.

In addition, a ring-shaped concave groove 12b is formed on the outer circumference of the cylindrical section 12 on the rear side.

The fin main body 13 has a shaft 13a extending in the frontward-rearward direction. A support arm 13b, as an example of a first dispersion portion and as an example of a support target portion, is formed to extend to the outer side in the radial direction is formed on the front end of the shaft 13a. The outer end of the support arm 13b is connected to the inner circumferential surface of the cylindrical section 12. Further, four support arms 13b of Example 1 are provided at an interval of 90° in the circumferential direction of the bottle 1.

A dispersion protrusion 13c, as an example of a second dispersion portion, is formed on the outer end portion of the support arm 13b in the radial direction. The dispersion protrusion 13c of Example 1 is formed to have a rod shape extending in the frontward-rearward direction. In FIG. 4, the dispersion protrusion 13c of Example 1 corresponds to a discharge port 28 to be described below, and extends to a position at which the dispersion protrusion and the discharge port 28 are overlapped in the axial direction. In addition, four dispersion protrusions 13c of Example 1 are provided to correspond to the support arm 13b at an interval of 90° in the circumferential direction.

In FIG. 5, the dispersion protrusion 13c of Example 1 has an inclined surface 14 with respect to the rotational center. The inclined surface 14 in Example 1 is configured of a surface inclined with respect to the rotational center as close to the downstream side in a rotational direction Ya. In addition, a perpendicular surface 15 with respect to the inclined surface 14 is formed in the dispersion protrusion 13c of Example 1 on the inner side in the radial direction. The perpendicular surface 15 is configured to have a perpendicular surface with respect to the rotational direction Ya. Hence, the dispersion protrusion 13c of Example 1 is formed to have a pentagonal shape close to a trapezoidal shape in which a portion of a corner of a rectangle is cut out in the dispersion protrusion 13c.

A coupling 16, as an example of a driving transmitting target member, is supported in the rear end of the shaft 13a. In a case where the toner cartridge TC is mounted on the printer main body U1, the coupling 16 is meshed to the coupling supported in the printer main body U1 and driving is transmitted.

In FIG. 4 and FIG. 5, a toner seal 17, as an example of a leakage preventing member, is supported on the rear end surface of the cylindrical section 12. The toner seal 17 is formed to have an annular shape, a so-called ring shape, along the rear end surface of the cylindrical section 12. Further, the toner seal 17 is formed of an arbitrary material which may prevent a leakage of the developer and it is possible to employ a foaming member such as sponge, or the like.

A flange 21, as an example of a fixing section, is supported on the rear side of the fin member 11. The flange 21 is configured of the cylindrical shape. The flange 21 has a mid-diameter portion 22 on the front portion, a large-diameter section 23 at the center in the frontward-rearward direction, and a small-diameter 24 of the rear portion.

The mid-diameter portion 22 has a sufficient inner diameter so as to cover the outer circumference of the rear portion of the rotation sections 1 and 11. A claw portion 22a, as an example of a connection section, is formed in the mid-diameter portion 22. The claw portion 22a is disposed at a position corresponding to the ring-shaped concave groove 12b and extends toward the inner side in the radial direction. The claw portion 22a is in contact with the concave groove 12b and regulates the rotation sections 1 and 11 to move frontward with respect to the flange 21. In other words, the rotation sections 1 and 11 and the flange 21 communicate with each other by the claw portion 22a.

A ring-shaped protrusion 23a, as an example of an entering portion, is formed at the front end of the large-diameter portion 23. Hence, the protrusion 23a is supported in a state of compressing the toner seal 17 such that the protrusion enters the toner seal 17 in a case where the flange 21 and the rotation sections 1 and 11 are connected to each other.

A plate-shaped wall section 26 extending in the upward-downward direction and the rightward-leftward direction is formed at a boundary portion between the large-diameter portion 23 and the small-diameter portion 24. The coupling 16 penetrates the wall section 26 to be rotatably supported on the wall section 26.

A discharge path 27 extending downward is formed below the wall section 26. The discharge port 28, as an example of the discharge portion, is formed at the lower end of the discharge path 27.

A shutter 29, as an example of an openable and closable member, is supported in the lower section of the discharge path 27 to be able to move in the frontward-rearward direction. The shutter 29 moves between an opened position at which the discharge port 28 is opened and a closed position at which the discharge port 28 is closed, depending on the insertion and removal of the toner cartridge TC. Further, since, as a configuration of moving of the shutter 29 depending on the insertion and removal of the toner cartridge TC, for example, various configurations in the related art may be employed, detailed description thereof is omitted.

In FIG. 3, an insertion guide 31, as an example of a guiding target section, is formed in the outer circumferential surface of the small-diameter portion 24. The insertion guide 31 is guided by a guide section (not illustrated), which is provided in the printer main body U1 as an example of a main body of the image forming apparatus, in a case where the toner cartridge TC is mounted.

Here, in Example 1, the toner, with which the toner bottle 1 is filled, has a compression ratio of 0.35 to 0.45 and has low fluidity. Further, the compression ratio is desirably 0.35 to 0.45. In a case where the compression ratio is less than 0.35, a problem arises in that the fluidity is excessively high and the toner is likely to be excessively supplied. On the other hand, in a case where the compression ratio is more than 0.45, the fluidity is excessively low and there is a concern that clogging by the toner will occur.

Further, toners and carriers having different compression ratios, for example, may be prepared in the following method.

Preparation of Resin Fine Particle Dispersion (1)

| | | |
|---|---|---|
| Adduct of 2 mols of bisphenol A ethylene oxide | 25 | parts |
| Adduct of 2 mols of bisphenol A propylene oxide | 25 | parts |
| Terephthalic acid | 30 | parts |
| Succinic acid | 5 | parts |
| Trimellitic anhydride | 15 | parts |

The above substances are put in a round-bottomed flask including a stirring device, a nitrogen guiding tube, a temperature sensor, and a rectifying column and are heated to 200° C. using a mantle heater. Subsequently, nitrogen gas is introduced through the gas introducing tube and an inert gas atmosphere is maintained and is stirred in the flask. Then, 0.05 parts of dibutyltin oxide is added with respect to 100 parts of a raw material mixture, a temperature of a reactant is maintained to be 200° C., reaction is performed for four hours, and then a resin (1) is obtained.

Subsequently, the obtained resin (1) is in a molten state and is transferred at a speed of 100 g per minute to an emulsifying machine (Cavitron CD1010, manufactured by Eurotech Ltd). Diluted ammonia water having concentration of 0.40%, which is obtained by diluting reagent ammonia water with ion-exchanged water, is put in an aqueous medium tank which is separately prepared. The diluted ammonia water is heated to 120° C. in a heat exchanger and is transferred to the emulsifying machine at a speed of 0.1 liter per minute along with the polyester resin melt. In this state, the emulsifying machine is operated under a condition in which a rotation speed of a rotor is 60 Hz and pressure is 0.49 Mpa (5 kg/cm²) and a resin fine particle dispersion (1) is obtained.

### Preparation of Releasing Agent Dispersion

-Releasing Agent Dispersion (1)-

| | | |
|---|---|---|
| Polyethylene wax (manufactured by Toyo Petrolite co., | 50 | parts |
| Ltd. Polywax 725, melting temperature: 102° C.) | | |
| Anionic surfactant (DKS Co. Ltd., Neogen RK) | 5 | parts |
| Ion-exchanged water | 200 | parts |

After the respective components above are mixed, the resultant is heated to 110° C. and melted, and is dispersed using a homogenizer (manufactured by IKA Works, Inc., Ultra-Turrax T50), a dispersion process is performed by using a Manton Gaulin high-pressure homogenizer (Gaulin) and a releasing agent dispersion (1) (concentration of releasing agent: 20%), in which a releasing agent having a volume average particle diameter of 220 nm is dispersed, is prepared.

Preparation of colorant dispersion (1)

| | | |
|---|---|---|
| Cyan pigment (manufactured by Dainichi Seika Co., Ltd., | 1,000 | parts |
| Pigment Blue 15:3 (copper phthalocyanine)) | | |
| Anionic surfactant (DKS Co. Ltd., Neogen R) | 150 | parts |
| Ion-exchanged water | 9,000 | parts |

The above substances are mixed, are resolved, and are dispersed for about one hour using Ultimizer (Sugino Machine Limited, HJP30006) as a high pressure impact type dispersing machine, in which a colorant (cyan pigment) is dispersed, such that colorant dispersion (1) is prepared. In the colorant dispersion (1), a volume average particle diameter of a colorant (cyan pigment) is 0.15 μm and particle concentration of the colorant is 23%.

Preparation of Toner Particles

| | | |
|---|---|---|
| Resin fine particle dispersion (1) | 400 | parts |
| Releasing agent dispersion (1) | 50 | parts |
| Colorant dispersion (1) | 22 | parts |

These substances are added in the round stainless steel flask, and then 1.5 parts of 10% of poly aluminum chloride aqueous solution (manufactured by Asada Chemical Co., Ltd.) is put in, and 0.1 N of a nitric acid aqueous solution is regulated to have the system of pH 2.5. Then, the obtained content is stirred at room temperature for 30 minutes, is mixed, is dispersed in the homogenizer (manufactured by IKA Works, Inc., Ultra-Turrax T50), is stirred and heated to 45° C. in an oil bath for heating, and is left to stand for 30 minutes. Subsequently, after 50 parts of resin dispersion is additionally added, the obtained content is heated to 50° C., and is left to stand for one hour.

When the obtained content is observed using an optical microscope, it is verified that agglomerated particles having a particle diameter of substantially 7.5 μm are generated. In aqueous sodium hydroxide, pH is regulated to be 7.5, then, the content is heated to 80° C. using the oil bath for heating and is left to stand for two hours. The content is cooled to room temperature, is filtered, is sufficiently purified using the ion-exchanged water, is dried using a vacuum drier, and then toner particles are obtained.

Colloidal silica (manufactured by Nippon Aerosil Co., Ltd., R972) is added in an amount of 1.7 parts with respect to 100 parts of the respective obtained toner particles, is externally mixed in a Henschel mixer, and toner for developing an electrostatic image, which has a compression ratio of 0.34, is obtained.

Colloidal silica (manufactured by Nippon Aerosil Co., Ltd., R972) is added in an amount of 1.5 parts with respect to 100 parts of the respective obtained toner particles, is externally mixed in a Henschel mixer, and toner for developing an electrostatic image, which has a compression ratio of 0.35, is obtained.

Colloidal silica (manufactured by Nippon Aerosil Co., Ltd., R972) is added in an amount of 1.2 parts with respect to 100 parts of the respective obtained toner particles, is externally mixed in a Henschel mixer, and toner for developing an electrostatic image, which has a compression ratio of 0.4, is obtained.

Colloidal silica (manufactured by Nippon Aerosil Co., Ltd., R972) is added in an amount of 0.7 parts with respect to 100 parts of the respective obtained toner particles, is externally mixed in a Henschel mixer, and toner for developing an electrostatic image, which has a compression ratio of 0.44, is obtained.

Colloidal silica (manufactured by Nippon Aerosil Co., Ltd., R972) is added in an amount of 0.5 parts with respect to 100 parts of the respective obtained toner particles, is externally mixed in a Henschel mixer, and toner for developing an electrostatic image, which has a compression ratio of 0.45, is obtained.

Colloidal silica (manufactured by Nippon Aerosil Co., Ltd., R972) is added in an amount of 0.4 parts with respect to 100 parts of the respective obtained toner particles, is externally mixed in a Henschel mixer, and toner for developing an electrostatic image, which has a compression ratio of 0.46, is obtained.

### Evaluation of Fluidity of Toner

It is possible to obtain, by the following equation, the compression ratio of the toner using a powder tester (Hosokawa Micron Ltd).

compression ratio=[(hardened apparent density)−(loose apparent density)]/(hardened apparent density)

### Operation of Example 1

In the printer U of Example 1 including the configuration, in a state in which the toner cartridge TC is mounted in the printer main body U1, the fin member 11 and the bottle 1 rotate when driving is transmitted to the coupling 16 in response to consumption of the toner. When the bottle 1 rotates, the developer is transported rearward along the spiral groove 2. Hence, in the toner cartridge TC of Example 1, the transport member which rotates, does not need to be in the inside of the bottle and thus it is possible to reduce manufacturing costs of the toner cartridge TC.

The developer transported rearward along with the rotation of the bottle 1 is supplied to the toner supply device TH1 through the discharge port 28.

In a case where replacing the toner cartridge TC in Example 1, if the toner cartridge has been stored for a long period of time before being replaced, or vibrates during transport, a developer is compacted, agglomerated, and then enters a lump-like state, in some cases. When the bottle 1 and the fin member 11 rotate in a state in which the developer is compacted, a driving force, that is, so-called torque, of a motor required when the developer is dispersed by using the fin main body 13 is increased, compared to a case in which the developer is not compacted.

Particularly, in Example 1, the developer with relatively low fluidity having the compression ratio is 0.35 to 0.45 is used. Accordingly, in the toner cartridge TC of Example 1, when the bottle 1 or the flange 21 does not have a great inner diameter, clogging by the developer is likely to occur, compared to a case in which the developer having high fluidity is used. In comparison, when the bottle 1 or the like has a great inner diameter and vibration is applied in a state in which the flange 21 is disposed on the lower side, a larger amount of developer is likely to be compacted in the flange 21, compared to a case in which the bottle 1 or the like has small inner diameter. Hence, the driving force, that is, so-called torque, of a motor required when the developer is dispersed, is likely to be increased.

Here, as disclosed in the related art, in a case where a plate-like stirring section (76) extending in the radial direction is used, the torque is increased when the developer is compacted. Hence, there is a need to employ a large motor so as to rotate the plate-like stirring section (76), and thus, a problem arises in that manufacturing costs increase. In addition, when the stirring section (76) rotates by large torque, stress produced in the developer is increased, and a problem arises in that the developer is degraded.

In addition, as disclosed in the related art, in a configuration in which the developer is dispersed through vibration and twisting during the mounting of the toner cartridge, a part of the toner cartridge is connected with a flexible member, the configuration is complicated, and strength is likely to result in a problem. In addition, a problem arises in that the compacted developer is unlikely to be sufficiently dispersed only by dispersing though twist.

Further, as disclosed in the related art, when the transport fin section (5a) is disposed on the upstream side from the toner support port (6) in the transport direction of the developer, a problem arises in that it is difficult to disperse the developer in the vicinity of the toner support port (6) even when the toner bottle (1) rotates in a state in which the developer is compacted.

In comparison, in Example 1, the dispersion protrusion 13c extends to a position at which the dispersion protrusion and the discharge port 28 are overlapped in the axial direction, and thus, it is possible to disperse the developer in the vicinity of the discharge port 28. In addition, the dispersion protrusion 13c is formed in the fin member 11 to have a shape extending in the axial direction at the outer end portion in the radial direction. Accordingly, the dispersion protrusion receives low resistance from the developer, compared to a plate shape extending in the radial direction. Hence, in Example 1, a case where the torque required for the driving is excessively increased is less likely to occur. Accordingly, there is no need to use a large motor, and manufacturing costs are reduced. Hence, in Example 1, even for the developer with relatively low fluidity, of which the compression ratio is 0.35 to 0.45, the torque is not excessively increased and thus it is possible to smoothly discharge the developer.

Further, in Example 1, multiple dispersion protrusions 13c are arranged in the circumferential direction. Accordingly, performance of dispersing developer is improved, compared to a case where only one protrusion is provided.

In addition, in Example 1, the inclined surface 14 and the perpendicular surface 15 are formed in the dispersion protrusion 13c. In a case where the inclined surface 14 is not formed, the perpendicular surface 15 comes into contact with and disperses the compacted developer when the fin member 11 rotates, and thereby the torque is likely to be increased. In comparison, in Example 1, the inclined surface 14 is formed, and the torque required when dispersing the developer is reduced, compared to a case in which the inclined surface 14 is not formed.

Further, in Example 1, the inclined surface 14 is configured of the surface which is inclined with respect to the rotational center as close to the downstream side in the rotational direction Ya. Accordingly, the developer brought into contact with the inclined surface 14 is pushed to the outer side in the radial direction due to the rotation of the fin member 11. Hence, the developer on the inner side in the radial direction is sent toward the discharge port 28 on the outer side in the radial direction. Accordingly, the inclined surface 14 supplements to transport the developer to the discharge port 28. Hence, a supply amount of the developer per unit time through the discharge port 28 is likely to be stable, compared to the case where the inclined surface 14 is not formed. Particularly, in Example 1, multiple dispersion protrusions 13c are arranged at equal interval in the circumferential direction, and thus, the stable discharging is likely to be performed, compared to a case where one dispersion protrusion is provided or multiple dispersion protrusions are not arranged at equal intervals.

### EXPERIMENTAL EXAMPLES

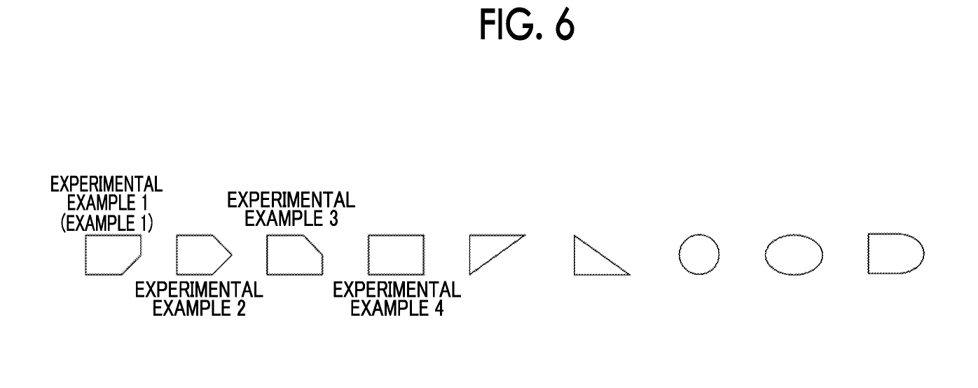

FIG. 6 is a view illustrating an experimental example, a shape of a second dispersion unit used in the experimental example, and a modification example of the second dispersion unit.

Next, an experiment is performed for verifying the effects of Example 1.

The experiment is performed by remodeling DocuCenter-IV C5570 manufactured by Fuji Xerox Co., Ltd. Further, the developer having fluidity of 0.39 is used. In addition, the toner cartridge TC after tapping is performed 600 times is used. Further, in the experiment, an experiment of measuring a change in torque with respect to the number of rotations and an experiment of measuring a change in a discharge amount, a so-called discharge rate per unit time with respect to the driving time of a motor are performed.

### Experimental Example 1

In Experimental Example 1, similar to Example 1, the dispersion protrusion 13c with a shape having the inclined surface 14 and the perpendicular surface 15 is used.

### Experimental Example 2

In Experimental Example 2, in a state viewed from rear, a dispersion protrusion, in which inclined surfaces are formed on the inner side and the outer side in the radial direction, and thus, an end on the downstream side in the rotational direction has a pointed shape, that is, a so-called gable-shaped dispersion protrusion is used.

### Experimental Example 3

In Experimental Example 3, in a state viewed from rear, a dispersion protrusion, in which an inclined surface is formed only on the inner side in the radial direction, is used. Experimental Example 4

In Experimental Example 4, in a state viewed from rear, a rectangular dispersion protrusion, in which no inclined surface is formed, is used.

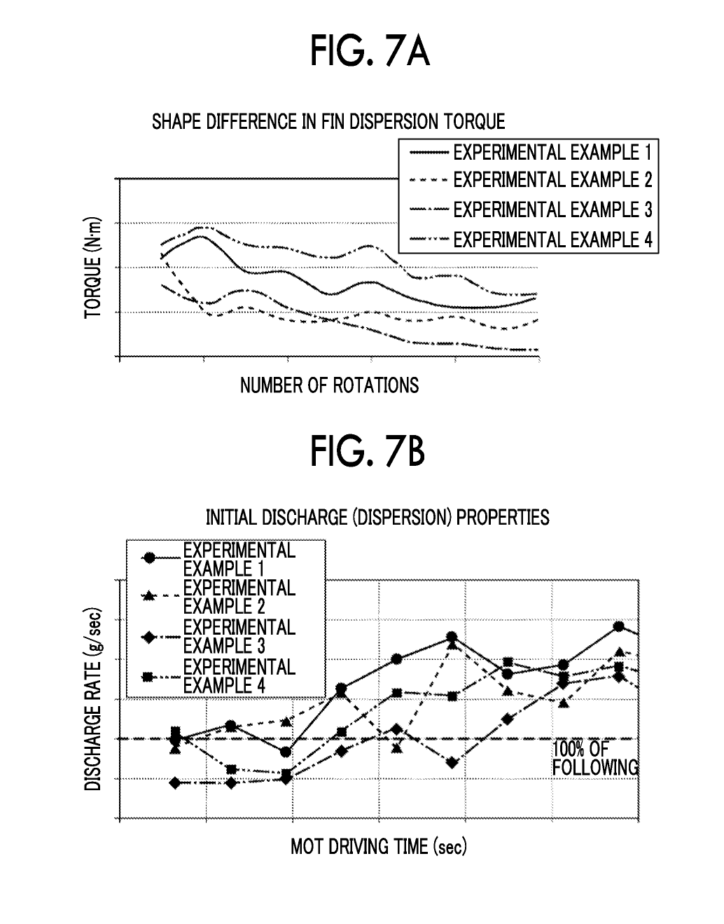

FIGS. 7A and 7B show the experimental results.

FIGS. 7A and 7B are graphs of the experimental results, FIG. 7A is a graph having the number of rotations on the horizontal axis and torque on the vertical axis, and FIG. 7B is a graph having motor driving time on the horizontal axis and discharge rate on the vertical axis.

In FIG. 7A, in the experiment of change in torque, it is verified that Experimental Examples 2 and 3 are more preferable than Experimental Examples 1 and 4. In addition, in FIG. 7B, it is verified that Experimental Examples 1 and 2 are more preferable than Experimental Examples 3 and 4 in changes in the discharge rate.

Hence, from the experimental results in FIGS. 7A and 7B, it is verified that the torque or the discharge rate is changed depending on the shape of the dispersion protrusion 13c.

### MODIFICATION EXAMPLES

Hereinafter, an Example of the invention will be described in detail; however, the invention is not limited to the Example, and various modifications may be performed within a range of a gist of the invention described in the claims. Modification examples (H01) to (H06) of the invention are listed in the following description.

(H01) In the Example, a printer, as an example of the image forming apparatus, is described; however, the invention is not limited thereto. For example, the invention is applicable to an image forming apparatus such as a copy machine, or a FAX machine.

(H02) In the Example, the configuration, in which the flange 21 is disposed on the front side of the toner cartridge TC in a mounting direction, that is, the back side of the printer main body U1, is described; however, the invention is not limited thereto. For example, it is possible to employ a configuration in which the flange 21 or the like is disposed on the rear side in the mounting direction, that is, on the front side of the printer main body U1.

(H03) In the Example, the number of dispersion protrusions 13c is not limited to four as in Example; however, one or more, three or less, and five or more dispersion protrusions may be provided. In addition, it is desirable that the dispersion protrusions 13c are arranged at equal intervals in the circumferential direction, but may be arranged at irregular intervals.

(H04) In the Example, a shape of the dispersion protrusion 13c is not limited to the shapes as in Example and Examples 1 to 4, but any shapes such as a triangular shape, a round shape, an oblong shape, a shell shape, or the like depicted as modifications illustrated in FIG. 6 may be performed depending on design or specification.

(H05) In the Example, the configuration, in which the toner seal 17 is disposed on the rotation sections 1 and 11 side and the protrusion 23a is disposed on the flange 21, is described; however, it is possible to switch the positions.

(H06) In the Example, the configuration, in which the coupling 16 which drives the bottle 1 is provided at the rear end, is described; however, the invention is not limited thereto. For example, it is possible to employ a configuration, in which a shape of the coupling is formed on the front end of the bottle 1, or a gear is formed on the outer circumferential surface of the bottle 1, and the bottle 1 is rotated.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A developer-containing vessel comprising:
a fixing section that includes a discharge portion through which developer is discharged;
a rotation section that includes a container in which the developer is contained and a dispersion member which is supported to be integrally rotatable along with the container and disperses the developer during rotation, and that is supported to be rotatable with respect to the fixing section; and
a transport portion that is formed in the container, is inclined with respect to a rotational axis direction of the rotation section, and transports the developer during the rotation of the rotation section,
wherein the dispersion member includes a first dispersion portion that extends from a rotational center in a radial direction and a second dispersion portion that extends from an outer end of the first dispersion portion in an axial direction, and extends to a position corresponding to the discharge portion,
wherein the second dispersion portion has an inclined surface which is inclined with respect to the rotational center of the rotation section, and
wherein a perpendicular surface with respect to the rotation direction is provided on an inner side of the second dispersion portion in the radial direction.

2. The developer-containing vessel according to claim 1,
wherein a plurality of the second dispersion portions extend from outer ends of a plurality of the first dispersion portions in the radial direction respectively, and are arranged at intervals in a circumferential direction.

3. (canceled)

4. The developer-containing vessel according to claim 1,
wherein the inclined surface is formed on an outer end side of the second dispersion portion in the radial direction, and is inclined with respect to the rotational center side as close to the downstream side in the rotational direction of the rotation section, and
wherein the discharge portion is disposed on an outer side from the second dispersion portion in the radial direction.

5. An image forming apparatus comprising:
an image holding member;
a developing device that develops a latent image formed on a surface of the image holding member into a visible image; and
the developer-containing vessel according to claim 1, in which developer that is supplied to the developing device is contained.

6. The developer-containing vessel according to claim 2, wherein the plurality of second dispersion portions include two sets of second dispersion portions, the first set having two collinear second dispersion portions, and a line connecting the first set of second dispersion portions is perpendicular to a line connecting the second set of second dispersion portions.

7. The developer-containing vessel according to claim 1, wherein two perpendicular surfaces with respect to the rotation direction are provided on the second dispersion portion, including a first perpendicular surface abutting the inclined surface and a second perpendicular surface, the second perpendicular surface having a larger surface area than the first perpendicular surface.
